(19) United States
(12) Patent Application Publication
(10) Pub. No.: US 2025/0259178 A1
(43) Pub. Date: Aug. 14, 2025

(54) SYSTEMS AND METHODS FOR SECURING TRANSACTIONS USING A GENERATIVE ARTIFICIAL INTELLIGENCE MODEL

(71) Applicant: Wells Fargo Bank, N.A., San Francisco, CA (US)

(72) Inventors: Manpreet Singh, San Francisco, CA (US); Sotirios Konstantinos Barkas, San Jose, CA (US); John Andrew Chuprevich, Davidson, NC (US)

(73) Assignee: Wells Fargo Bank, N.A., San Francisco, CA (US)

(21) Appl. No.: 18/441,923

(22) Filed: Feb. 14, 2024

(51) Int. Cl. G06Q 20/40; G06Q 20/38

(52) U.S. Cl. CPC G06Q 20/4016; G06Q 20/3829; G06Q 2220/00

(57) ABSTRACT

A provider computing system includes a processing circuit having at least one processor coupled to at least one memory device and at least one artificial intelligence (AI) system. The processing circuit performs operations including receiving a first request for a first transaction having one or more first parameters; analyzing a transaction history comprising one or more previous transactions having at least one of the one or more first parameters; determining a response to the first request; and transmitting the response to the first request. The at least one AI system is configured to perform operations including: simulating one or more transactions; identifying one or more second parameters of the one or more simulated transactions; comparing the one or more second parameters to the one or more first parameters; and determining a legitimacy value associated with the first transaction based on the comparison.

### TECHNICAL FIELD

The present disclosure relates generally to fraud detection, more specifically to using generative artificial intelligence to identify indicators of error and/or fraud in a transaction.

### BACKGROUND

As electronic transaction computing systems become increasingly popular, fraudsters are finding more complex and intricate methods of accessing user accounts and submitting fraudulent transaction requests on their behalf. The transaction computing systems, therefore, have to face these fraudsters with improved technology for detecting potential fraud without creating a burdensome transaction verification process for the user.

### SUMMARY

One embodiment relates to a method. The method includes: receiving, by a provider computing system and from a user device, a first request for a first transaction having one or more first parameters; analyzing, by the provider computing system, a transaction history comprising one or more previous transactions having at least one of the one or more first parameters; simulating, by the provider computing system using at least one artificial intelligence (AI) system, one or more transactions based on the one or more first parameters; identifying, by the provider computing system using the at least one AI system, one or more second parameters of the one or more simulated transactions; comparing, by the provider computing system using the at least one AI system, the one or more second parameters to the one or more first parameters; determining, by the provider computing system using the at least one AI system, a legitimacy value associated with the first transaction based on the comparison of the one or more second parameters to the one or more first parameters; determining, by the provider computing system, a response to the first request based on the legitimacy value associated with the first transaction; and transmitting, by the provider computing system to the user device, the response to the first request.

Another embodiment relates to a provider computing system. The provider computing system includes at least one processing circuit having at least one processor coupled to at least one memory device and at least one artificial intelligence (AI) system. The at least one memory device stores instructions thereon that, when executed by the at least one processor, cause the at least one processing circuit to perform operations including: receiving, from a user device, a first request for a first transaction having one or more first parameters; analyzing a transaction history comprising one or more previous transactions having at least one of the one or more first parameters; determining a response to the first request based on a legitimacy value associated with the first transaction; and transmitting, to the user device, the response to the first request. The at least one AI system is configured to perform operations including: simulating one or more transactions based on the one or more first parameters; identifying one or more second parameters of the one or more simulated transactions; comparing the one or more second parameters to the one or more first parameters; and determining the legitimacy value associated with the first transaction based on the comparison of the one or more second parameters to the one or more first parameters.

Still another embodiment relates to a non-transitory computer-readable medium having instructions stored thereon that, when executed by at least one processing circuit of a provider computing system associated with a provider institution, cause the at least one processing circuit to perform operations. The operations include: receiving, from a user device, a first request for a first transaction having one or more first parameters; analyzing a transaction history comprising one or more previous transactions having at least one of the one or more first parameters; simulating, using at least one artificial intelligence (AI) system, one or more transactions based on the one or more first parameters; identifying, using the at least one AI system, one or more second parameters of the one or more simulated transactions; comparing, using the at least one AI system, the one or more second parameters to the one or more first parameters; determining, using the at least one AI system, a legitimacy value associated with the first transaction based on the comparison of the one or more second parameters to the one or more first parameters; determining a response to the first request based on the legitimacy value associated with the first transaction; and transmitting, to the user device, the response to the first request.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 depicts a block diagram of a system with an artificial intelligence (AI) sub-system, according to an example embodiment.

FIG. 2 depicts a block diagram of the AI sub-system of FIG. 1 in greater detail, according to an example embodiment.

FIG. 3 depicts a block diagram of an AI model of the AI sub-system of FIG. 1, according to an exemplary embodiment.

FIG. 4 depicts a method of detecting fraudulent and/or error-laden transactions with the AI system of FIG. 1, according to an example embodiment.

FIG. 5 depicts additional steps of the method of FIG. 4, according to an example embodiment.

FIG. 6 depicts a user interface, according to an example embodiment.

FIG. 7 depicts another user interface, according to an example embodiment.

### DETAILED DESCRIPTION

As financial institutions work to create improved technology to guard against fraudsters, users are met with systems that require high amounts of bandwidth in order to operate and that require constant user input and verification. For example, in order to evaluate whether a submitted transaction request is fraudulent or not, a banking application may run a series of highly complex analyses. These analyses require significant amounts of bandwidth from a user device in order to operate, and thus significantly hinder the efficiency of the user device. Additionally, with existing technologies, transactions that include one or more errors may be automatically flagged as fraudulent and can lead to inconvenient automated responses such as card deactivation, account freezing, transaction cancellation, and so on.

The present disclosure presents more efficient and accurate systems, computer-readable media, and methods for detecting fraudulent and/or error-laden transactions. The present disclosure involves utilizing a generative AI model to simulate one or more transactions related to a submitted transaction request. By analyzing the one or more simulated transactions, in combination with one or more previous transactions and contextual information associated with the submitted transaction, the generative AI model can more efficiently and accurately identify indicators of error and/or fraud. The present disclosure may result in lower amounts of bandwidth and fewer user impositions required in order to detect fraudulent transactions and/or errors associated with a legitimate transaction.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

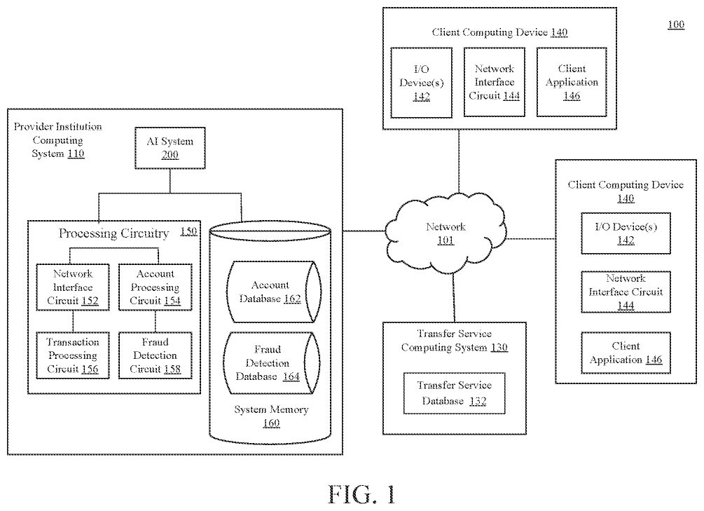

FIG. 1 is a diagram of a transaction securitization computing environment or system 100 for identifying potentially fraudulent and/or error-laden transactions, according to an example embodiment. As shown, the system 100 includes a provider institution computing system 110, a transfer service computing system 130, and at least one client computing device 140 (shown as two client computing devices, but there may be a plurality). The provider institution computing system 110, the transfer service computing system 130, and the client computing device 140 are in communication with each other and are connected by a network 101.

The network 101 can include any type or form of one or more networks. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the Asynchronous Transfer Mode technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

For clarity, the following description refers to a provider institution computing system 110, a transfer service computing system 130, and a client computing device 140. However, it may be understood that the following description of any of the provider institution computing system 110, the transfer service computing system 130, and/or the client computing device 140 may be similarly applicable to any corresponding additional provider institution computing system 110, transfer service computing system 130, and/or client computing device 140, respectively, and that, in some embodiments, the system 100 may include a plurality of any of the described devices and systems.

The provider institution computing system 110 is owned by, associated with, or otherwise operated by a provider institution (e.g., a bank or other financial institution) that maintains one or more accounts held by various customers (e.g., a customer associated with the client computing device 140), such as demand deposit accounts, credit card accounts, receivables accounts, and so on. In some instances, the provider institution computing system 110, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider institution computing system 110 may include and/or have various other devices communicably coupled thereto, such as, for example, desktop or laptop computers (e.g., tablet computers), smartphones, wearable devices (e.g., smartwatches), and/or other suitable devices.

In some embodiments, the provider institution computing system 110 includes an artificial intelligence (AI) system 200, a processing circuitry 150, and a system memory 160. Although not specifically shown, it may be appreciated that the provider institution computing system 110 may include one or more I/O devices. The one or more I/O devices are configured to receive inputs from and display information to a user. While the term “I/O” is used, it should be understood that the I/O devices may be input-only devices, output-only devices, and/or a combination of input and output devices.

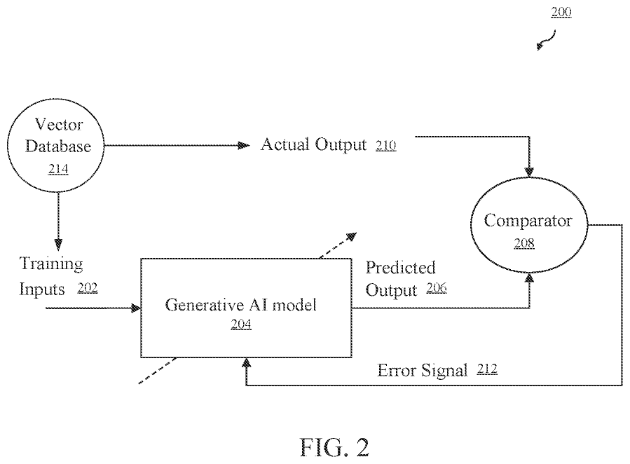

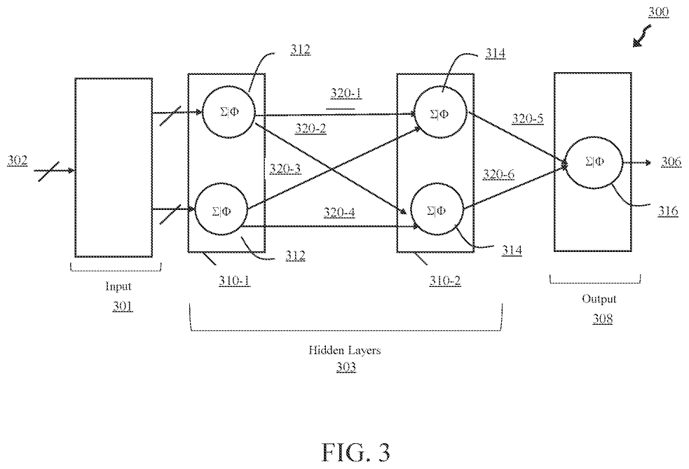

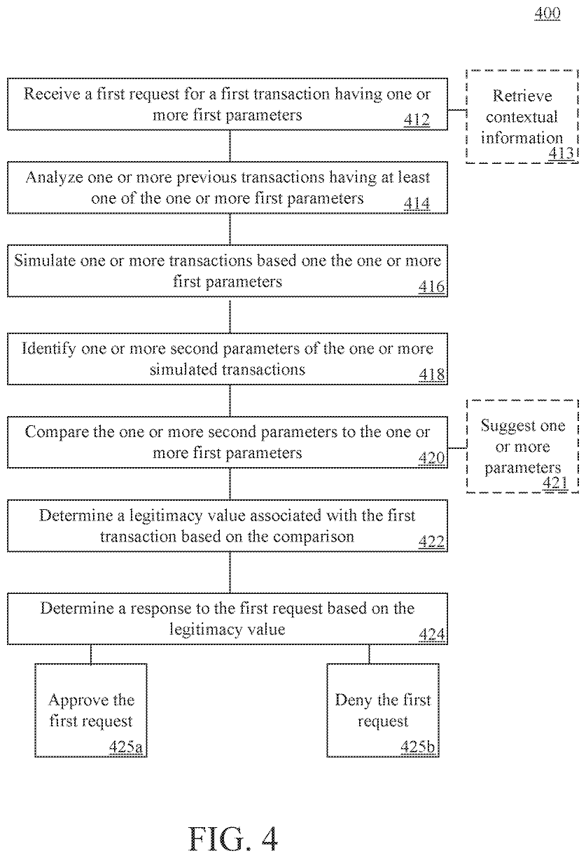

The AI system 200 may include one or more servers, databases, or cloud computing environments that may execute one or more AI models, and particularly generative AI models as described herein (e.g., generative AI model 204, as described in greater detail below with reference to FIGS. 2-3). The generative AI models may include, but are not limited to, large language models (LLMs), which can be trained to generate human-like text, speech, images, and/or components of graphical user interfaces. The generative AI models may be structured using a deep learning architecture that includes a multitude of interconnected layers, including attention mechanisms, self-attention layers, and transformer blocks. The generative AI models are trained on large datasets to assimilate patterns, structures, and relationships within the data. The trained generative AI models can be trained to generate outputs that resemble or closely resemble the characteristics of the input data. For example, the generative AI models may be trained to simulate one or more transactions that resemble or closely resemble the characteristics (e.g., parameters) of an input transaction, as described below, with reference to FIG. 4. The generative AI models may be fine-tuned to generate specific output data, including data that is compatible with various database architectures or provider computing systems. The generative AI models can be trained via optimization of a large number of parameters, in which the generative AI models learn to minimize the error between its predictions and the actual data points, resulting in highly accurate and coherent generative capabilities.

The processing circuitry 150 includes one or more processing circuits including one or more processors coupled to one or more memory devices. The processing circuitry 150 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuitry 150 can include a memory operable to store or storing one or more instructions for operating components of the processing circuitry 150 and operating components operably coupled to the processing circuitry 150. For example, the one or more instructions can include one or more of firmware, software, hardware, operating systems, embedded operating systems. The memory may include one or more devices (e.g., RAM, ROM, Flash memory, hard disk storage) for storing data and/or computer code for completing and/or facilitating the various processes described herein. The memory may include non-transient volatile memory, non-volatile memory, and non-transitory computer storage media, database components, object code components, script components, or any other type of information structure for supporting the various activities and information structures described herein. The processing circuitry 150 of the provider institution computing system 110 can include one or more communication bus controllers to effect communication between the processing circuitry 150 and the other elements of the provider institution computing system 110. In some embodiments, the one or more processing circuits may include a network interface circuit 152, an account processing circuit 154, a transaction processing circuit 156, and a fraud detection circuit 158.

In some instances, the network interface circuit 152 includes, for example, program logic that connects the provider institution computing system 110 to the network 101. The network interface circuit 152 facilitates secure communications between the provider institution computing system 110 and the client computing device(s) 140 and the transfer service computing system 130. The network interface circuit 152 also facilitates communication with other entities, such as other banks, settlement systems, and so on. The network interface circuit 152 further includes user interface program logic configured to generate and present web pages to users accessing the provider institution computing system 110 over the network 101.

The network interface circuit 152 may include one or more antennas and associated communications hardware. For example, the network interface circuit 152 may include a network antenna. The network interface circuit 152 further includes any one or more of a cellular transceiver (e.g., CDMA, GSM, LTE, etc.), a wireless network transceiver (e.g., 802.11X, ZigBee, WI-FI, Internet, etc.), and/or a combination thereof (e.g., both a cellular transceiver and a wireless network transceiver).

The account processing circuit 154 is structured or configured to perform a variety of functionalities or operations to enable, implement, and monitor various customer activities (e.g., account processing, product registration processing, account monitoring, etc.) in connection with customer account information stored within the account database 162. In some instances, the account processing circuit 154 performs various functionalities to enable account opening and/or closing actions, product registration and/or closing actions (e.g., registering for and/or closing a transaction service account associated with a transaction service provided by the transfer service computing system 130), account withdrawals and deposits (e.g., account credits and debits to checking and savings accounts), various customer account tracking activities, and/or a variety of other services associated with and/or provided by the provider institution. In some instances, the account processing circuit 154 is configured to, for each customer activity performed, automatically or nearly automatically pull customer account information (e.g., from the account database 162) pertaining to the customer and customer account associated with the customer activity and to transmit the customer account information to the fraud detection circuit 158 to be used in a fraud detection, as described below, with reference to FIG. 4.

The transaction processing circuit 156 is structured or configured to enable and monitor various customer transactions (e.g., the customer sending funds to a recipient, the customer receiving funds from a sender). In some instances, the transaction processing circuit 156 is further structured to incorporate at least some of the functionalities offered by the transfer service computing system 130 (e.g., via one or more APIs and/or SDKs of the transfer service computing system 130) to allow for customers to send and receive transfers of funds using transfer service tokens (e.g., via a client application 146 provided to the client computing device 140 by the provider institution computing system 110). Accordingly, in some instances, the transaction processing circuit 156 is further structured to enable and monitor various transactions and/or transfer service fund transfers conducted by the customers.

In some instances, the transaction processing circuit 156 is structured to, for each transaction and/or transfer service fund transfer performed by each customer of the provider, automatically pull customer account information associated with the customer (e.g., from the account database 162), as well as sender/recipient account information associated with the sender and/or recipient (e.g., from the transfer service computing system 130), associated with a particular transaction or transfer service fund transfer. The transaction processing circuit 156 is then structured to transmit both the customer information and the sender/recipient information to the fraud detection circuit 158 to be used in a fraud detection, as described below, with reference to FIG. 4.

The fraud detection circuit 158 is structured to enable various functionalities described herein. For example, in some instances, the fraud detection circuit 158 is structured to perform a fraud detection process, such as that which is described in detail below with respect to FIG. 4. In some instances, the fraud detection circuit 158 is further structured to receive (e.g., automatically or nearly automatically upon various customer activities and transactions) or pull (e.g., upon a predetermined schedule) various customer activity information, customer transaction information, and/or customer account information from the account processing circuit 154, the account database 162, the transaction processing circuit 156, the fraud detection database 164, and/or the transfer service computing system 130 (e.g., a transfer service database 132) to enable the fraud detection.

The system memory 160 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The system memory 160 may be or include tangible, non-transient volatile memory or non-volatile memory. The system memory 160 may also include database components, object code components, script components, or any other type of information structure for supporting the activities and information structures described in the present application.

In the example shown, the system memory 160 may further include an account database 162 and a fraud detection database 164. According to an exemplary embodiment, the system memory 160 is communicably coupled to the processing circuitry 150 and includes computer code for executing (e.g., by the processing circuitry 150 and/or the one or more processing circuits) one or more processes described herein.

The account database 162 is structured or configured to retrievably store customer account information associated with various customer accounts held or otherwise maintained by the provider institution on behalf of its customers. In some instances, the customer account information includes both customer information and account information pertaining to a given customer account. For example, in some instances, the customer information may include a name, a phone number, an e-mail address, a physical address, an occupation, etc. of the customer associated with the customer account. In some instances, the account information may include transaction information, information pertaining to the type and corresponding capabilities of the given account, a transfer service token (e.g., a phone number, an e-mail address, or a tag associated with a particular transfer service account) associated with the customer account, etc. of the customer account. As described in greater detail below, the account database 162 is configured to be used by the account processing circuit 154, the transaction processing circuit 156, and the fraud detection circuit 158 to identify various customer account information associated with various transactions and other activities (e.g., account openings and closings, document validations, fund transfers, etc.) to enable the transactions and other activities while actively mitigating the risk of fraudulent activity.

The fraud detection database 164 is structured or configured to retrievably store various fraud detection information associated with customers and corresponding customer accounts held or otherwise maintained by the provider institution, as well as fraud detection information pertaining to potentially fraudulent sender and/or recipient identifying information. For example, the fraud detection circuit 158 may identify a customer account held or otherwise maintained by the provider or a particular sender or recipient as potentially associated with fraudulent transactions. The fraud detection circuit 158 is structured to store associated customer account information and/or the potentially fraudulent sender or recipient identifying information within the fraud detection database 122. In these instances, the customer account information and/or the potentially fraudulent sender or recipient identifying information may be flagged as potentially fraudulent within the fraud detection database 164. Accordingly, in some instances, the fraud detection circuit 158 may additionally pull various fraud detection information from the fraud detection database 164 when performing the fraud detection, as described below, with respect to FIG. 4.

The transfer service computing system 130 is controlled by, managed by, owned by, and/or otherwise associated with a transfer service entity (e.g., Zelle®, Billpay, online wire transfer services) that is configured to enable real-time or nearly real-time transfers between users. As described herein and in one embodiment, the “transfer” is a transfer of resources, such as a payment or fund transfer. In some instances, the payment or fund transfer may include electronic or digital fund transfers.

In some instances, the transfer service entity may be provided by a financial institution (e.g., a card network) or other entity that supports transfers across multiple different entities (e.g., across different financial institutions). In some instances, the transfer service entity may, for example, be an entity that is formed as a joint venture between banks and/or other entities that send and receive funds using the system 100. As another example, the transfer service entity may be a third-party vendor. As still another example, the transfer service entity may be provided by the provider institution, such that the provider institution performs both the operations described herein as being performed by the provider institution computing system 110 and the operations described herein as being performed by the transfer service computing system 130.

In some embodiments, the transfer service computing system 130 may, for example, include one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. Although not specifically shown, it may be appreciated that the transfer service computing system 130 may include a network interface circuit, various databases (e.g., similar to the transfer service database 132), an account processing circuit, and other circuits in the same or similar manner to the other components of system 100. In some instances, the network interface circuit may include user interface program logic configured to generate and present application pages, web pages, and/or various other data to users accessing the transfer service computing system 130 over the network 101.

The transfer service computing system 130 is configured to enable real-time or nearly real-time transfers between registered users of the transfer service. For example, in some instances, during a registration process, the transfer service computing system 130 is configured to receive one or more transfer service tokens (e.g., a Zelle® identifier), such as a phone number, an e-mail address, an alphanumeric tag, etc., to be associated with an entity (e.g., the customer or any other user) registering for the transfer service. During the registration process, the transfer service computing system 130 is further configured to receive various account information (e.g., a bank routing number, a bank account number) and identifying information (e.g., a name, a phone number, an e-mail address, a physical address) associated with the entity to be linked to the corresponding received transfer service token(s) for registering the entity with the transfer service.

Accordingly, in some instances, the transfer service computing system 130 is configured to receive a registration request from the provider institution computing system 110 and/or the client computing device 140 to register the customer. In some instances, the registration request includes a desired transfer service token, the account information, and the identifying information associated with the customer. Upon receiving the registration request, the transfer service computing system 130 is configured to store the transfer service token, the account information, and the identifying information for the customer within a transfer service database 132 and to link the transfer service token to the account information and the identifying information within the transfer service database 132 to register the customer with the transfer service.

Once the transfer service token, the account information, and the identifying information for the customer have been stored and linked within the transfer service database 132, the transfer service computing system 130 is configured to, upon receipt of a transfer request (e.g., received from the provider institution computing system 110 or the client computing device 140), query the transfer service database 132 to retrieve the corresponding account information and identifying information associated with recipient and sender transfer service tokens included in the requested transfer. Once the corresponding account information is successfully retrieved by the transfer service computing system 130, the transfer service computing system 130 is configured to initiate a transfer (e.g., of funds) from an account associated with the sender to an account associated with the recipient.

As discussed above, the transfer service database 132 stores transfer service tokens, corresponding account information, and corresponding identifying information for various transfer service accounts that are maintained by the transfer service on behalf of its customers. The transfer service database 132 is configured to be used by the transfer service computing system 130 to enable the real-time or near real-time transfers discussed above.

In some instances, the transfer service computing system 130 is configured to provide (e.g., through its own client application or through integration with a client application of another entity, such as client application 146) at least some of the functionality depicted in the figures and described herein. For example, in some instances, as discussed above, at least some of the functionality performed by the transfer service computing system 130 is integrated within a banking application (e.g., one of the client applications 146) provided by the provider institution computing system 110 to the client computing device 140. For example, in some instances, the transfer service computing system 130 includes one or more APIs and/or SDKs that securely communicate with the provider institution computing system 110 and allow for various functionality performed by the transfer service computing system 130 to be embedded within the client application 146 provided by the provider institution computing system 110 to the client computing device 140.

The user device or client computing device 140 is owned, operated, controlled, managed, and/or otherwise associated with a user (e.g., a customer of the provider institution). In some embodiments, the client computing device 140 may be or may include, for example, a desktop or laptop computer (e.g., a tablet computer), a smartphone, a wearable device (e.g., a smartwatch), a personal digital assistant, and/or any other suitable computing device. In the example shown, the client computing device 140 is structured as a mobile computing device, namely a smartphone. As shown in FIG. 1, the system 100 may include two client computing devices 140. For example, one of the two client computing devices 140 may be operated by a first party associated with a transaction (e.g., a sending party), while the other of the two client computing devices may be operated by a second party associated with the transaction (e.g., a receiving party). It should be understood that multiple client computing devices 140 may be included in the system 100 and that the depiction of two is not meant to be limiting.

In some embodiments, the client computing device 140 includes one or more I/O devices 142, a network interface circuit 144, and at least one client application 146. Again, while the term “I/O” is used, it should be understood that the I/O devices 142 may be input-only devices, output-only devices, and/or a combination of input and output devices. In some instances, the I/O devices 142 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 142 further include one or more user interfaces (devices or components that interface with the customer), which may include one or more biometric sensors (such as a fingerprint reader, a heart monitor that detects cardiovascular signals, a face scanner, an iris scanner, etc.).

The network interface circuit 144 includes, for example, program logic and various devices (e.g., transceivers, etc.) that connect the client computing device 140 to the network 101. The network interface circuit 144 facilitates secure communications between the client computing device 140 and each of the provider institution computing system 110 and the transfer service computing system 130. The network interface circuit 144 also facilitates communication with other entities, such as other banks, settlement systems, and so on.

The client computing device 140 stores in computer memory, and executes (“runs”) using one or more processors, the client application 146. The client computing device 140 may also execute a variety of other applications, such as an Internet browser application, a text messaging application (e.g., for sending MMS or SMS to the provider institution computing system 110 and/or the transfer service computing system 130), and/or an application provided or authorized by entities implementing or administering certain of the operations described herein.

For example, in some instances, the client application 146 is a provider institution client application provided by and at least partly supported by the provider institution computing system 110 (e.g., a financial institution banking application, such as a mobile banking application). For example, in some instances, the client application 146 coupled to the provider institution computing system 110 may enable the customer to perform various customer activities (e.g., account management, account opening and/or closing actions, account withdrawals and deposits) and/or perform various transactions (e.g., the customer sending funds to a recipient, the customer receiving funds from a sender, etc.) associated with one or more customer accounts of the customer held at the provider institution associated with the provider institution computing system 110.

In some other instances, the client application 146 provided by the provider institution computing system 110 may additionally be coupled to the transfer service computing system 130 (e.g., via one or more application programming interfaces (APIs) and/or software development kits (SDKs)) to integrate one or more features or services provided by the transfer service computing system 130. For example, in some instances, the provider institution computing system 110 may integrate a transfer service provided by the transfer service computing system 130 for transferring funds between users of the transfer service using transfer service tokens, as described below, into the client application 146. In some other instances, the transfer service computing system 130 may alternatively provide the transfer service via a separate client application 146.

Accordingly, the client applications 146 are structured to provide the customer with access to various services offered by the provider institution and/or the transfer service. In some embodiments, the client applications 146 are hard coded onto the memory of the client computing device 140. In some embodiments, the client applications 146 are web-based interface applications, where the customer has to log onto or access the web-based interface before usage, and these applications are supported by a separate computing system comprising one or more servers, processors, network interface circuits, or the like (e.g., the provider institution computing system 110, the transfer service computing system 130), that transmit the applications for use to the client computing device 140.

Referring now to FIG. 2, a block diagram of the AI system 200 using supervised learning is shown, according to an example embodiment. Supervised learning is a method of training an AI model given input-output pairs. An input-output pair is an input with an associated known output (e.g., an expected output). More specifically, a generative AI model 204 may provide a method of supervised learning that, upon being trained by a plurality of input-output pairs, is configured to generate outputs based on unknown inputs.

The generative AI model 204 may be trained on known input-output pairs such that the generative AI model 204 can learn how to predict known outputs given known inputs. Once the generative AI model 204 has learned how to predict known input-output pairs, the generative AI model 204 can operate on unknown inputs to predict an output.

The generative AI model 204 may be trained based on general data and/or granular data (e.g., data based on a specific user) such that the generative AI model 204 may be trained specific to a particular user (e.g., a user with a customer account at the provider institution).

Training inputs 202 and actual outputs 210 may be provided to the generative AI model 204. Training inputs 202 may include one or more transaction parameters, contextual information, and the like. Actual outputs 210 may include one or more previous transactions, fraudulency indicators (e.g., data stored in the fraud detection database 164), and the like. In some embodiments, the training inputs 202 and the actual outputs 210 may first enter a vector database 214 of the AI system 200 before the training inputs are provided to the generative AI model 204. The vector database 214 is configured to parse the training inputs 202 and the actual outputs 210 to identify a string of one or more terms from the training inputs 202 and the actual outputs 210. The string of one or more terms may then be converted to one or more corresponding vectors that represent each of the one or more terms. The one or more corresponding vectors are stored in the vector database 214.

The training inputs 202 and actual outputs 210 may be received from one or more data sources of the system 100. The one or more data sources may include one or more internal data sources (e.g., the account database 162, the fraud detection database 164) and/or one or more external data sources (e.g., the client computing device 140, the transfer service database 132, third-party data sources). The one or more internal data sources may be accessible within the provider institution computing system 110. The one or more external data sources may be accessible over the network 101. For example, the one or more internal data sources may provide account information associated with a user, one or more fraudulency indicators, a transaction history, and so on. The one or more external data sources may provide parameters surrounding a transaction request (e.g., submitted by a user via the client application 146 on the client computing device 140), account information (e.g., stored in the transfer service database 132), contextual information (e.g., retrieved from the third-party data sources), and so on. Thus, the generative AI model 204 may be trained to simulate one or more transactions based on the training inputs 202 and the actual outputs 210 used to train the generative AI model 204.

In some embodiments, the generative AI model 204 may be trained to make one or more recommendations to the user based on current user data received from at least one of the processing circuitry 150, the system memory 160, the transfer service database 132, and the client computing device 140. That is, the generative AI model 204 may be trained using the training inputs 202, such as one or more parameters associated with a transaction request, to predict outputs 206, such as one or more simulated transactions, by applying the current state of the generative AI model 204 to the training inputs 202. The comparator 208 may compare the predicted outputs 206 to actual outputs 210 (e.g., one or more previous transactions) to determine an amount of error or differences. The actual outputs 210 may be determined based on historic data associated with the recommendation to the user.

During training, the error (represented by error signal 212) determined by the comparator 208 may be used to adjust the weights in the generative AI model 204 such that the generative AI model 204 changes (or learns) over time. The generative AI model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the generative AI model 204 such that the algorithmic weights adapt based on the amount of error. The error is minimized using a loss function. Non-limiting examples of loss functions may include the square error function, the root mean square error function, and/or the cross-entropy error function.

The weighting coefficients of the generative AI model 204 may be tuned to reduce the amount of error, thereby minimizing the differences between (or otherwise converging) the predicted outputs 206 and the actual outputs 210. The generative AI model 204 may be trained until the error determined at the comparator 208 is within a certain threshold (or a threshold number of batches, epochs, or iterations have been reached). The trained generative AI model 204 and associated weighting coefficients may subsequently be stored in a training database, as described below, such that the generative AI model 204 may be employed on unknown data (e.g., not training inputs 202). Once trained and validated, the generative AI model 204 may be employed during a testing (or an inference phase). During testing, the generative AI model 204 may ingest unknown data to predict future data (e.g., one or more simulated transactions having one or more second parameters).

Referring to FIG. 3, a block diagram of a simplified neural network model 300 is shown. The neural network model 300 may be implemented and utilized by the AI system 200. The neural network model 300 may include a stack of distinct layers (vertically oriented) that transform a variable number of inputs 302 being ingested by an input layer 301, into an output 306 at the output layer 308.

The neural network model 300 may include any number of hidden layers 310 between the input layer 301 and output layer 308. Each hidden layer has a respective number of nodes (312, 314 and 316). In the neural network model 300, the first hidden layer 310-1 has nodes 312, and the second hidden layer 310-2 has nodes 314. The nodes 312 and 314 perform a particular computation and are interconnected to the nodes of adjacent layers (e.g., nodes 312 in the first hidden layer 310-1 are connected to nodes 314 in a second hidden layer 310-2, and nodes 314 in the second hidden layer 310-2 are connected to nodes 316 in the output layer 308). Each of the nodes (312, 314 and 316) sum up the values from adjacent nodes and apply an activation function, allowing the neural network model 300 to detect nonlinear patterns in the inputs 302. Each of the nodes (312, 314 and 316) are interconnected by weights 320-1, 320-2, 320-3, 320-4, 320-5, 320-6 (collectively referred to as weights 320). Weights 320 are tuned during training to adjust the strength of the node. The adjustment of the strength of the node facilitates the neural network's ability to predict an accurate output 306.

In some embodiments, the output 306 may be one or more numbers. For example, output 306 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

Although not specifically shown, it may be appreciated that the AI system 200 may include a training database that stores training data configured to train the generative AI model 204. The training data refers to information relating to previous operations and/or activity (e.g., analyses, comparisons, simulations, responses, etc.) performed by the generative AI model 204 in response to the provider institution computing system 110 receiving a transaction request. In some embodiments, a subset of the training data may be associated with a user account (e.g., a customer account held or otherwise maintained by the provider institution). The subset of the training data refers to information relating to the previous operations and/or activity performed by the generative AI model 204 in response to receiving a transaction request from the user account (e.g., via the client application 146). The training database may be configured to associate the subset of the training data with the user account by tagging the subset of the training data with an account identifier. The account identifier refers to a unique characteristic (e.g., a personal identification number (pin), an account number, a routing number, biometric information, etc.) associated with the user account. For example, the training database may identify a subset of the training data as relating to a transaction request from a specific user account and thereafter tag that subset of the training data with the account identifier associated with the specific user account. In some embodiments, the training database may retrieve the account identifier from the account database 162, the transfer service database 132, or the client computing device 140.

In some embodiments, the generative AI model 204 may be configured to perform the operations and/or activity using a subset of the training data associated with other user accounts in response to receiving a transaction request from a particular user account. In some embodiments, the generative AI model 204 may be configured to identify the other user accounts based on a common set of parameters between the other user accounts and the particular user account. The common set of parameters may include common account information (e.g., a shared geographical location, a shared occupation, etc.), common transaction parameters (e.g., a shared second party associated with the transaction, a shared transaction method, a shared transaction amount, a shared merchant category code (MCC), etc.), a common transaction history (e.g., one or more previous transactions having shared transaction parameters), etc. In this instance, the particular user account may not be associated with any subsets of the training data. For example, the particular user account may be newly activated or the particular user account may not have a transaction history.

The generative AI model 204 may be configured to use subsets of the training data associated with the other user accounts until the subset of the training data associated with the particular user account reaches a threshold amount. The threshold amount refers to a quantity of data associated with a predetermined number of transaction requests (e.g., 5, 15, 25, etc.) submitted by the user to the provider institution computing system 110. In some embodiments, the predetermined number of transaction requests may be determined by a security standard implemented by the provider institution. For example, the security standard implemented by the provider institution may require that the threshold amount of training data associated with the particular user account include at least 15 transaction requests associated with the particular user account. By storing training data and associating the training data with a user account, the generative AI model 204 may perform personalized fraud and/or error detection depending on the user account associated with the transaction to avoid unnecessary fraudulent flags and to accurately identify one or more errors in any given transaction request.

With an example structure of the system 100 being described above, example processes performable by the system 100 (or components/systems thereof) are described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring to FIG. 4, a flow diagram of a method 400 for securing transactions using an AI system is shown, according to an example embodiment. Various operations of the method 400 may be conducted by the system 100 and particularly parts thereof (e.g., the provider institution computing system 110, the client computing device 140, and the transfer service computing system 130).

In some embodiments, the method 400 may begin upon a user accessing the client application 146. The user may submit at least one authentication credential (e.g., a username, a password, a pin code, a biometric such as a facial scan or a fingerprint, a combination thereof, etc.) to access the client application 146. The client application 146 may, via the network interface circuit 144 of the client computing device 140, transmit the authentication credential to the provider institution computing system 110. The provider institution computing system 110 may validate/verify the authentication credential. In some embodiments, the client application 146 may itself validate/verify the authentication credentials.

As shown in FIG. 4, the method 400 may include the provider institution computing system 110 receiving, upon successful authentication of the user, a first request for a first transaction having one or more first parameters, at step 412. The provider institution computing system 110 may receive the first request from the client computing device 140 via the client application 146. The first request may be associated with a user account (e.g., a customer account by which the user accesses the client application 146). In some embodiments, the transaction processing circuit 156 may receive the first request.

The first request refers to an input from a user (e.g., a customer of the provider institution) prompting the provider institution computing system 110 to facilitate a transaction. In some embodiments, the user can specify at least one of the one or more first parameters in the first request. The one or more first parameters refer to parameters for the transaction. For example, the user may indicate parameters, such as a receiving party, a transfer amount, a transfer method, a desired completion date for the transfer, etc. The one or more first parameters may be included with the first request. When the provider institution computing system 110 receives the first request via the client application 146, user account information may be associated with the first request. The user account information may specify at least one of the one or more first parameters. For example, if a transfer of funds to another account is requested from a client computing device 140 via the client application 146, a sending party may be specified as the user associated with the user account with which the client application 146 is launched.

The first transaction refers to a transaction associated with/defined by the first transaction request. The first transaction may involve various parties of the system 100 (e.g., at least one sender and at least one recipient, etc.).

The first transaction may be a variety of transactions, such as a transfer of funds, an account activation and/or deactivation, a document validation (e.g., a notary service), etc. For example, the first transaction may include a user (e.g., a homeowner) paying a recipient (e.g., a contractor) in exchange for a service (e.g., a home improvement project). As another example, the first transaction may include a user sending a document with a notarization request to the provider institution computing system 110 from the client computing device 140.

As alluded to above, the one or more first parameters refers to one or more parameters characterizing the first transaction. For example, the one or more first parameters may include at least one of a transaction amount, one or more parties associated with the first transaction, a transaction method (e.g., a communication channel, a payment channel, etc.), a desired completion date of the transaction, and so on. The one or more first parameters may be identified by the processing circuitry 150 of the provider institution computing system 110 (e.g., the account processing circuit 154, the transaction processing circuit 156) or by the transfer service computing system 130 (e.g., the transfer service database 132). For example, the account processing circuit 154 may identify, from the first request, an account number to which the first transaction requires a transfer of funds. The account number may be identified based on the identified parties to the transaction (e.g., from a client application 146 ID associated with the customer client application). In some embodiments, the account processing circuit 154 may receive a token representative of the account number associated with the client application 146. The account processing circuit 154 may cross-reference the token against a plurality of tokens stored in the account database 162 to verify the account number. From the account number, the account processing circuit 154 may identify a user account (e.g., from the account database 162, the transfer service database 132). The transaction processing circuit 156 may then identify the user associated with the identified user account as one of the one or more parties associated with the first transaction.

The transaction amount refers to a quantity of funds being exchanged as part of the first transaction. For example, the transaction amount may include an amount of currency (e.g., $5,000, £300, £20, etc.) being paid from one user (e.g., a payer) to a second user (e.g., a payee). As a non-monetary example, the transaction amount may refer to one or more documents included in the first transaction that require or may require an action, such as a notarization service.

The one or more parties associated with the first transaction refers to one or more entities involved in the first transaction. The one or more parties may include one or more users having a customer account at the provider institution. In some embodiments, the one or more parties may include a human being, a business, the provider institution, or any other entity. In some embodiments, the one or more parties may be identified by a customer account from which the first request is received (e.g., identified by the account processing circuit 154, as described above), or by one or more other entities (e.g., a customer, a business, etc.) designated on the first request (e.g., by a name, by an account number, by a routing number, etc.).

The one or more parties associated with the first transaction may further include at least one of a sending party (e.g., a payer, a provider, etc.) and a receiving party (e.g., a payee, a receiver, etc.). The sending party refers to an entity configured to provide the transaction amount associated with the first transaction. In some embodiments, the sending party is a user with an account at the provider institution. The sending party may be a user associated with the account from which the provider institution computing system 110 receives the first request (e.g., via the client application 146). The receiving party refers to an entity configured to receive the transaction amount associated with the first transaction. In some embodiments, the receiving party is a user with an account at the provider institution. The receiving party may be designated (e.g., by name, by account number, by routing number, etc.) in the first request. In some embodiments, one of the sending party or the receiving party may be absent from the first request. In such an instance, the generative AI model 204 may be configured to suggest one of the receiving party or the sending party, respectively, as described below, in reference to step 421.

The transaction method refers to a means or methodology by which the first transaction is performed. The transaction method may include a communication channel, a payment channel, a transfer service, etc., over which the provider institution computing system 110 conducts or enables the first transaction. In some embodiments, the transaction method may include a transaction service operated by the transfer service computing system 130. In some embodiments, the transaction method may include a transaction method enabled by the transaction processing circuit 156. The transaction method may be indicated in the first request (as a parameter). In some embodiments, the transaction method may be a preferred transaction method associated with a user account of the user who submits the first request. For example, if the provider institution computing system 110 receives a transfer request from the client computing device 140 via the client application 146, the client application 146 being accessed through a user account designating Zelle® as a default transfer service, the transfer may be performed using Zelle®.

Receiving the first request may further include retrieving contextual information, at step 413. The contextual information refers to information regarding various conditions, circumstances, and so on, surrounding the first transaction. In some embodiments, the contextual information includes information relating to the one or more first parameters. For example, the contextual information may provide additional information relating to the transaction amount, to the one or more parties associated with the first transaction, or to the transaction method. The contextual information may be retrieved by the provider institution computing system 110 from at least one data source. The at least one data source may include one or more internal data sources associated with the provider institution (e.g., the account database 162, the fraud detection database 164) and/or one or more external data sources (e.g., the transfer service database 132, the client computing device 140, one or more third-party data sources).

For example, the contextual information relating to the transaction amount may include a cost of living for a geographical location where the first transaction takes place. The cost of living may be data received by the provider institution computing system 110 from one or more third-party data sources (e.g., economic reports, census information, other publicly recorded information, etc.). For example, there may be a significant discrepancy (e.g., double the transaction amount) between a transaction where a customer purchases a cocktail at a bar if the transaction takes place in New York City versus if the transaction takes place in Wausau, Wisconsin. In some embodiments, the contextual information relating to the transaction amount may include a currency used in the geographical location where the first transaction takes place. For example, in a transaction including a transfer of funds from a first user to a second user via a transfer service entity (e.g., Zelle®, Billpay, online wire transfer services), the first user may initiate the transaction from a first location with a first currency (e.g., the United States). The account information of the second user, however, may indicate that the second user resides in a second location with a second currency (e.g., India). With this contextual information relating to the geographic location of the one or more parties associated with the transaction, the provider institution computing system 110 can convert the transfer amount from the first currency (e.g., $100) to the second currency (e.g., [symbol] 8,329.77).

The contextual information may further include information related to the one or more parties associated with the transaction. For example, the contextual information may include location information associated with the one or more parties. In some instances, the location information may be retrieved by identifying a physical address (e.g., a home address, a business address, etc.) associated with a user account of the one or more parties from the account database 162. In some instances, the client application 146, via the client computing device 140, may transmit a data payload that includes a location identifier (e.g., GPS information) associated with the client computing device 140. The contextual information related to the one or more parties associated with the transaction may include account information (e.g., stored in the account database 162) when the one or more parties is identified by a user account via the client application 146. In some embodiments, the account information reveals contextual information such as an age, a marital status, a number of dependents, an occupation, and so on, associated with the one or more parties.

As another example, the contextual information related to the one or more parties associated with the transaction may further include the occupation of the one or more parties associated with the transaction. In some embodiments, identifying the occupation of the one or more parties may protect against fraudulent transactions by detecting a reasonableness of the transaction amount given the occupation of the one or more parties. The reasonableness of the transaction amount refers to a range of transaction amounts that may be expected for a given occupation. In some embodiments, the range of the transaction amounts that may be expected for a given occupation may be determined by the generative AI model 204. The generative AI model 204 may calculate a mean transaction amount among all of the transaction amounts for a transaction associated with one or more parties of a given occupation. From the mean transaction amount, the generative AI model 204 may determine the range by calculating a standard deviation associated with the mean transaction amount and determining whether the transaction amount falls within one, two, or three standard deviations of the mean. If the transaction amount does not fall within one, two, or three standard deviations of the mean, the transaction amount may be considered unreasonable (e.g., an outlier) given the occupation of the one or more parties involved.

For example, a transaction may include a request to transfer funds from a user to a hairstylist. The generative AI model 204, upon identifying that the occupation of one or more parties involved is a hairstylist, determines a range of expected transaction amounts based on the transaction amounts of previous transactions involving a hairstylist. The generative AI model 204 can determine whether the transaction amount associated with the request is reasonable based on whether the transaction amount lies within the range of the expected transaction amounts. A request to transfer $500 from the user to the hairstylist, for instance, may be identified as potentially fraudulent by the generative AI model 204 because the transaction amount lies outside of the range of expected transaction amounts for transactions involving a hairstylist. In this case, the generative AI model 204 may be configured to analyze other contextual information surrounding the transaction before determining that it is fraudulent. For example, the contextual information may indicate that the user is a mother who lives in Manhattan. The contextual information may be determined from a number of dependents and the physical address associated with the user account. In this case, the contextual information may provide an explanation as to why the transaction amount lies outside of the range of the expected transaction amounts. The generative AI model 204 therefore performs personalized fraud detection such that the transaction is not erroneously flagged as fraudulent before considering additional contextual information that may be relevant for this request associated with this user.

The contextual information may also include information related to the transaction method. As described above, a preferred transaction method may be determined based on user account information (e.g., if a particular transaction method is not already designated on a transaction request). The preferred transaction method may be stored in the account database 162 or otherwise linked to a user account by which the client application 146 is accessed. In some embodiments, the geographic location and/or the currency associated with a transaction request may determine the transaction method. For example, if the transaction request involves a transfer of funds between two or more users in two or more geographical locations, each of which uses a different currency, the contextual information may indicate that the transaction method is a transfer service that facilitates multiple-currency transfers. If at least one of the user accounts involved in this transaction designates Zelle® as a preferred transaction method, the contextual information in this example may indicate that the transaction method for this transaction may not be the preferred transaction method but is another transaction method that facilitates multiple-currency transfers.

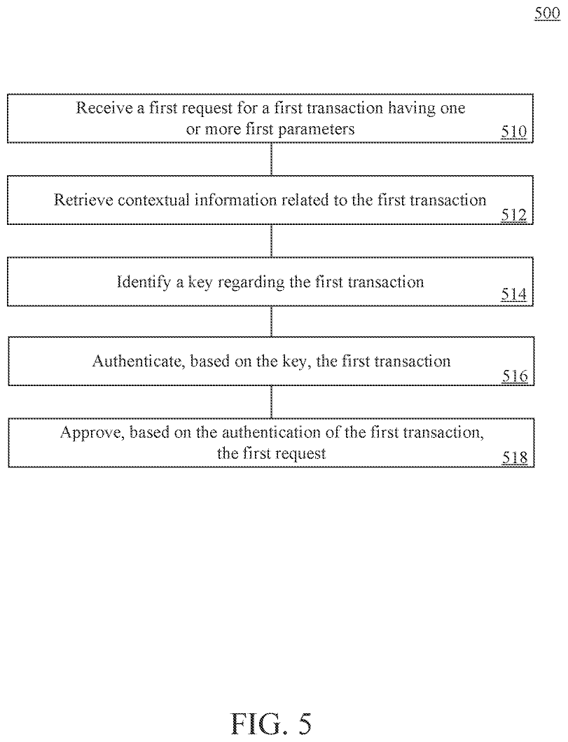

In some embodiments, the contextual information may be used to determine at least one of the one or more first parameters. As described above, the contextual information may be used to determine the transaction method associated with a particular transaction. The contextual information may also be used to determine the one or more parties associated with the transaction. For example, if a user initiates a transaction involving a transfer of funds related to a kitchen renovation project, the transaction request may include the transaction amount, the transaction method (e.g., via a transfer service), and a comment box (e.g., to indicate what the transaction relates to), but may not designate a receiving party. The provider institution computing system 110 may use the geographical location of the first user (e.g., from a home address associated with the user account stored in the account database 162) and information included in the comment box (e.g., “kitchen renovation payment no. 3”) to determine the receiving party. The provider institution computing system 110 may access a transfer service database (e.g., transfer service database 132) associated with the transfer service included in the transaction and identify one or more home renovation companies that operate in the geographical location of the user (e.g., in the same city, in the same county, etc.). The one or more home renovation companies may be provided (e.g., via the client application 146 on the client computing device 140) to the user in response to receiving the transaction request. The contextual information may also be used to determine the transaction amount associated with the transaction. For example, continuing with transaction relating to the kitchen renovation project, the transaction request may alternatively include the transaction method, the comment box, and the receiving party, but may not designate the transaction amount. The contextual information, however, may be used to identify the range of the transaction amounts (e.g., determined by the generative AI model 204, as described above) that may be expected for an occupation relating to “contracting,” “construction,” “home improvement,” “home renovation,” and so on. The range of the transaction amounts may then be provided (e.g., via the client application 146 on the client computing device 140) to the user in response to receiving the transaction request. In some embodiments, the contextual information may be used to identify a validation key regarding the first transaction, as described below, with reference to FIG. 5.

Once the provider institution computing system 110 has received the first request, at step 412, the provider institution computing system 110 analyzes a transaction history, at step 414. The transaction history refers to a record (e.g., a log, an array, a list, etc.) of one or more previous transactions. The one or more previous transactions included in the transaction history relate to at least one of the one or more first parameters associated with the first transaction. For example, the one or more previous transactions may relate to the one or more parties, the transaction amount, and/or the transaction method associated with the first transaction. The provider institution computing system 110 may retrieve the one or more previous transactions from one or more data sources (e.g., the account database 162, the transfer service database 132).

By analyzing the transaction history, the provider institution computing system 110 may identify trends among the one or more previous transactions. The trends among the one or more previous transactions refers to patterns within the one or more previous transactions relating to one of the first parameters associated with the first transaction. For example, the provider institution computing system 110 (e.g., the transaction processing circuit 156) may analyze a transaction history that includes the receiving party designated by the first request. The transaction processing circuit 156 may identify a common transaction method (e.g., a particular transfer service) among the one or more previous transactions included in the transaction history relating to the receiving party. By identifying the common transaction method, a transaction request associated with the receiving party and designating a transaction method other than the common transaction method identified among the one or more previous transactions may indicate the transaction request as potentially being fraudulent and/or containing one or more errors.

Once the provider institution computing system 110 has analyzed the transaction history, at step 414, the generative AI model 204 simulates one or more transactions, at step 416, based on the one or more first parameters. The one or more simulated transactions refers to one or more possible transactions that include or otherwise relate to the one or more first parameters of the first transaction. In some embodiments, the generative AI model 204 uses the subset of the training data stored in the training database, as described above, associated with an account of the user who submits the first request to simulate the one or more transactions. The generative AI model 204 may simulate the one or more transactions by first matching the one or more first parameters associated with the first transaction (e.g., received as training inputs 202) to one or more of the vectors in the vector database 214. For example, the generative AI model 204 may parse the first request to identify a string of one or more terms indicating the one or more parameters of the first transaction and match that string of one or more terms to a string of one or more terms that have been transformed into one or more vectors stored in the vector database 214. The generative AI model 204 may then combine one of the one or more matched vectors with one or more additional vectors from the vector database 214 to simulate a transaction. The one or more additional vectors may correspond to one or more parameters such that the simulated transaction includes at least a transaction amount, one or more parties, and a transaction method. In some embodiments, the generative AI model 204 may combine each of the one or more matched vectors with one or more additional vectors to simulate the one or more transactions.

In some embodiments, the one or more simulated transactions may relate to the contextual information surrounding the first transaction (e.g., the contextual information retrieved at step 413). For example, the one or more simulated transactions may relate to the cost of living associated with the geographical location of the first transaction. The contextual information may also be represented by one or more vectors stored in the vector database 214. The generative AI model 204 may then parse the contextual information to identify a string of one or more terms indicating the contextual information related to the first transaction and match that string of one or more terms to a string of one or more terms that have been transformed into one or more vectors stored in the vector database 214. In order to simulate the one or more transactions to match the contextual information associated with the first transaction, the generative AI model 204 may be configured to include the one or more vectors representing the contextual information in each of the one or more simulated transactions. For example, each of the one or more simulated transactions may then be simulated according to the cost of living associated with the first transaction such that disparate costs of living among the one or more simulated transactions do not cause the provider institution computing system 110 to inadvertently flag the first transaction as being potentially fraudulent and/or potentially containing one or more errors.

Once the generative AI model 204 has simulated the one or more transactions, at step 416, the generative AI model 204 then identifies one or more second parameters of the one or more simulated transactions, at step 418. The one or more second parameters refer to one or more parameters characterizing the one or more simulated transactions. In some embodiments, the one or more second parameters may be represented by the one or more additional vectors combined by the generative AI model 204 to simulate each of the one or more transactions (at step 416). For example, in a simulated transaction associated with the same receiving party as the first transaction, the one or more second parameters may include a transaction amount and a transaction method associated with the simulated transaction.

Once the generative AI model 204 has identified the one or more second parameters, at step 418, the generative AI model 204 compares the one or more second parameters to the one or more first parameters, at step 420. In some embodiments, the generative AI model 204 performs the comparison of the one or more second parameters to the one or more first parameters by identifying whether each of the one or more first parameters are included as second parameters in at least one of the one or more simulated transactions. Additionally or alternatively, the generative AI model 204 may perform the comparison of the one or more second parameters to the one or more first parameters by identifying whether each of the one or more first parameters falls within a predefined range of one or more second parameters of the one or more simulated transactions. The range of one or more second parameters may be determined by compiling each of the one or more second parameters related to a particular parameter (e.g., the transaction amount, the one or more parties, the transaction method) from each of the one or more simulated transactions. For example, in a first simulated transaction including the contextual information of the first transaction and including the same sending party and the same receiving party as the first transaction, the transaction amount (e.g., as indicated by one of the second parameters of the first simulated transaction) may be $40. In a second simulated transaction including the contextual information of the first transaction and including the same sending party and the same receiving party as the first transaction, the transaction amount (e.g., as indicated by one of the second parameters of the second simulated transaction) may be $60. Therefore, the generative AI model 204 may identify the range of the transaction amount as any transaction amount between $40 and $60. In comparing the one or more first parameters to the one or more second parameters, then, the generative AI model 204 may identify a first parameter indicating a transaction amount between $40 and $60 as falling within the range of the one or more second parameters.

The generative AI model 204 may be further configured to identify, from the one or more second parameters of the one or more simulated transactions, an average value of a particular parameter. Continuing with the example above, the generative AI model 204 may identify that the average value of the transaction amount, based on the transaction amounts of the one or more simulated transactions, is $50. From the average value, the predefined range of the one or more second parameters may be determined by applying an upper bound and a lower bound to the average value. For example, for an average value of $50, the generative AI model 204 may apply a $10 upper bound and a $10 lower bound to the average value. Therefore, the predefined range for the transaction amount would be $50+/−$10, or $40 to $60. In some embodiments, the predefined range may be determined by applying the upper bound and the lower bound to a median value of the one or more second parameters. For example, if the generative AI model 204 determines that the median value of the transaction amount from the one or more simulated transactions is $49, the predefined range may be $49+/−$10, or $39 to $59. In some embodiments, the generative AI model 204 may determine the predefined range using a minimum value and a maximum value of the one or more second parameters. For example, the generative AI model 204 may identify the minimum value of the transaction amount in the one or more simulated transactions to be $25. The generative AI model 204 may also identify the maximum value of the transaction amount in the one or more simulated transactions to be $65. In this example, the generative AI model 204 determines the predefined range of the transaction amount to be $25 to $65. Thus, the generative AI model 204 is configured to define the predefined range for the one or more first parameters based on the one or more second parameters of the one or more simulated transactions.

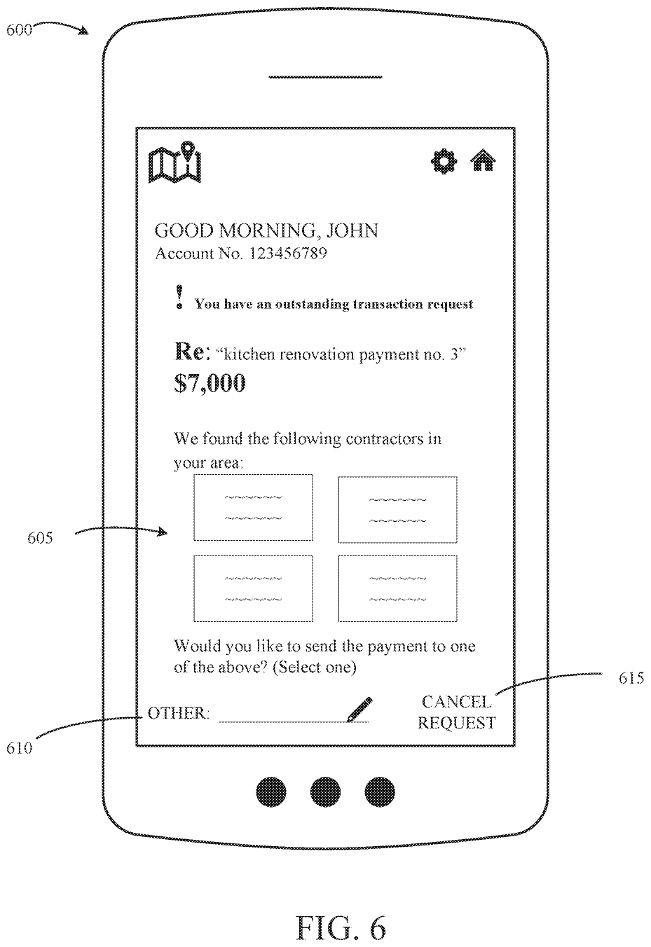

The provider institution computing system 110 may be further configured to suggest one or more parameters, at step 421. The one or more suggested parameters refers to one or more parameters associated with the first transaction that may not be designated by the first request for the first transaction. For example, the one or more suggested parameters may include at least one of a receiving party, a transaction amount, and/or a transaction method (among others). The one or more suggested parameters may be determined from at least one of the contextual information retrieved at step 413, the transaction history analyzed at step 414, and the one or more transactions simulated at step 416. In some embodiments, the provider institution computing system 110 may be configured to suggest the one or more parameters using a notification sent to the client computing device 140 via the client application 146. In some embodiments, the notification sent to the client computing device 140 may include one or more selectable elements configured to allow a user to accept the one or more suggested parameters or to reject the one or more suggested parameters, as described below with reference to FIG. 6. Upon receiving an indication that the user has accepted the one or more suggested parameters, the first request may be updated such that the one or more suggested parameters are included in the one or more first parameters.

For example, the provider institution computing system 110 may be configured to suggest a transaction method relating to a payment between the sending party and the receiving party. The suggested transaction method may be determined from at least one of the contextual information associated with the first transaction (e.g., a default transaction method designated on a customer account associated with one of the one or more parties involved in the first transaction), the transaction history (e.g., a common transaction method identified in each of the one or more previous transactions between the sending party and the receiving party), or the one or more second parameters (e.g., a transaction method associated with one of the one or more simulated transactions between the sending party and the receiving party). The suggested transaction method may include a specific payment method, a specific communication channel, a specific transfer service provider, and so on. In some embodiments, the suggested transaction method may be used by at least one of the receiving party to initiate (e.g., request from the sending party) the payment, the sending party to make (e.g., send, deliver, transfer, etc.) the payment, and the receiving party to collect (e.g., receive, deposit, etc.) the payment.

Once the generative AI model 204 has compared the one or more second parameters to the one or more first parameters, at step 420, the generative AI model 204 determines a legitimacy value associated with the first transaction based on the comparison of the one or more second parameters to the one or more first parameters, at step 422. The legitimacy value refers to a likelihood of the first transaction being fraudulent and/or containing one or more errors. In some embodiments, the legitimacy value includes a score (e.g., a number, a letter, a category, etc.) out of a predefined scale. The predefined scale may be determined by the provider institution and encoded into the AI system 200. The predefined scale may include any of a numerical range (e.g., 0-5, 0-10, 0-100, etc.), an alphabetical range (e.g., A, B, C, D, or F), a categorical range (e.g., very good, good, neutral, bad, very bad), and so on.

In some embodiments, the generative AI model 204 determines the legitimacy value associated with the first transaction by identifying an amount (e.g., a number, a ratio, a percentage, a fraction, etc.) of the one or more first parameters (including the one or more suggested parameters approved by a user) that are indicated by at least one of the contextual information, the transaction history, and the one or more second parameters. For example, if each of the first parameters associated with the first transaction are indicated by each of the contextual information, the transaction history, and the one or more second parameters, the first transaction may receive a relatively high legitimacy score out of the predefined scale (e.g., 5, 10, 100, A, very good). If one or more of the first parameters associated with the first transaction are indicated by at least one of the contextual information, the transaction history, and the one or more second parameters, the first transaction may receive a middle legitimacy score out of the predefined scale (e.g., 3, 5, 50, C, neutral). If none of the first parameters associated with the first transaction are indicated by at least one of the contextual information, the transaction history, and the one or more second parameters, the first transaction may receive a relatively lower legitimacy score (e.g., 0, F, very bad).

In some embodiments, the generative AI model 204 may assign each of the one or more first parameters associated with the first transaction an individual legitimacy value out of the predefined scale. The legitimacy value associated with the first transaction may then be determined by taking an average of the individual legitimacy values. For example, if one of the one or more first parameters is indicated by each of the contextual information, the transaction history, and the one or more second parameters, that one of the one or more first parameters may receive a highest individual legitimacy value out of the predefined scale (e.g., 5, 10, 100, A, very good). Alternatively, if one of the one or more parameters is indicated by none of the contextual information, the transaction history, or the one or more second parameters, that one of the one or more first parameters may receive a lowest legitimacy value out of the predefined scale (e.g., 0, F, very bad).

For example, if the sending party associated with the first transaction is indicated by each of the contextual information, the transaction history, and the one or more second parameters, the sending party parameter may receive, out of a 10-point scale, an individual legitimacy value of 10. If the receiving party associated with the first transaction is indicated by the transaction history but not by the contextual information nor the one or more second parameters, the receiving party parameter may receive, out of the 10-point scale, an individual legitimacy value of 3. If the transaction method associated with the first transaction is indicated by the contextual information and the transaction history but not by the one or more second parameters, the transaction method parameter may receive, out of the 10-point scale, an individual legitimacy value of 7. If the transaction amount associated with the first transaction is indicated by none of the contextual information, the transaction history, or the one or more second parameters, the transaction amount parameter may receive, out of the 10-point scale, an individual legitimacy value of 0. In this example, the first transaction may receive a legitimacy value of 5, out of the 10-point scale.

In some embodiments, the generative AI model 204 may store the legitimacy value associated with the first transaction and the individual legitimacy values associated with each of the one or more first parameters in the training database. By storing a plurality of legitimacy values and individual legitimacy values as training data, the generative AI model 204 may be designed to reduce the bandwidth required when detecting transactions as being potentially fraudulent and/or containing one or more errors. For example, the legitimacy values and the individual legitimacy values corresponding to one or more transaction requests from a particular user may be stored in a subset of training data associated with a customer account of the particular user. With this information stored in the subset of training data, the provider institution computing system 110 may require reduced bandwidth for the generative AI model 204 to perform fraud detection analysis on one or more future transaction requests associated with the particular user.

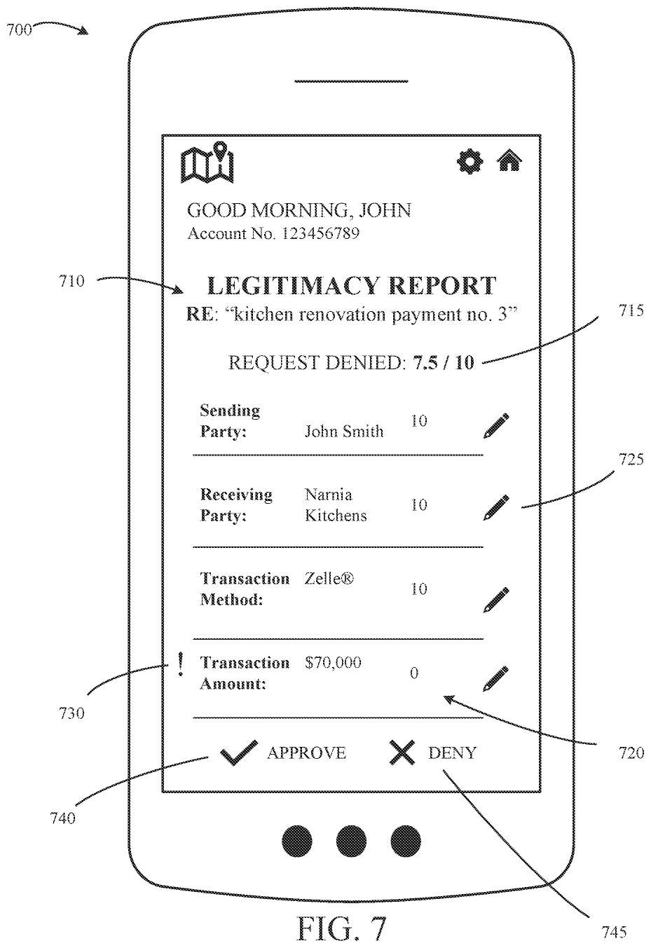

Once the provider institution computing system 110 has determined the legitimacy value associated with the first transaction, at step 422, the provider institution computing system 110 determines a response to the first request based on the legitimacy value, at step 424. The response refers to an action taken by the provider institution corresponding to the first request for the first transaction. In some embodiments, the response includes generating a legitimacy report (e.g., summary, assessment, etc.) associated with the first transaction, as described in greater detail with reference to FIG. 7.

In some embodiments, the response may include approving the first request, at step 425a, or denying the first request, at step 425b. Approving the first request may further include processing the first transaction as indicated by the first request. In some embodiments, the provider institution computing system 110 may approve the first request if the first transaction receives a predefined legitimacy (e.g., the highest legitimacy value out of the predefined scale). In some embodiments, approving the first request includes transmitting the first request to a transfer service (e.g., to the transfer service computing system 130) for the transfer service to complete a transfer of funds as indicated by the first transaction. Denying the first request may further include failing to process the first transaction as indicated by the first request. For example, the provider institution computing system 110 may deny the first request if the first transaction receives a legitimacy value that is lower than the highest legitimacy value out of the predefined scale.

Once the provider institution computing system 110 has determined the response to the first request, at step 424, the provider institution computing system 110 transmits the response to the first request via the network 101. In some embodiments, the response is transmitted to the client computing device 140 via the client application 146. Transmitting the response may include generating a graphical user interface configured to display the response to the user (e.g., interface 700, as described in greater detail below with reference to FIG. 7). In some embodiments, if the provider institution computing system 110 approves the first request, the provider institution computing system 110 may transmit a verification that the first request is approved and that the first transaction is being processed.

In some embodiments, the provider institution computing system 110 may transmit the legitimacy report (e.g., to the client computing device 140 via the client application 146) upon denying the first request. The legitimacy report may further include one or more selectable elements, as explained in greater detail below, with reference to FIG. 7. In some embodiments, upon receiving an indication of a user engagement with the one or more selectable elements, the provider institution computing system 110 may be configured to update the one or more first parameters associated with the first transaction according to the user engagement with the one or more selectable elements. The provider institution computing system 110 may then approve an updated first transaction that includes the one or more updated first parameters. Alternatively, upon receiving an indication of a user engagement with the one or more selectable elements, the provider institution computing system 110 may be configured to cancel the first transaction, flag the first transaction as fraudulent, and store data associated with the first transaction in the fraud detection database 164.

Based on the foregoing, method 400 may be performed in an example operation as follows. A user with an account at the financial institution may submit a transaction request, from a client computing device 140 via a client application 146, that involves transferring $70,000 to “Kitchen Contractors Group” (e.g., step 412). The provider institution computing system 110 may identify, from the account database 162, that the user has a preferred transfer service of Zelle® (e.g., step 413). The provider institution computing system 110 may also identify the geographical location of the user based on the location identifier associated with the client computing device 140 (e.g., step 413). The provider institution computing system 110 may analyze one or more previous transactions from a sending party to a receiving party called “Kitchen Contractors Group” within a geographical region including the geographical location of the user (e.g., step 414). From the one or more previous transactions, the provider institution computing system 110 may identify a Zelle® account associated with the receiving party included in each of the one or more previous transactions. The AI system 200, using the generative AI model 204, may simulate one or more transactions including at least one of the user as a sending party, the “Kitchen Contractors Group” as a receiving party, a transaction amount of $70,000, a transaction method of Zelle®, the geographical region including the geographical location of the user, the Zelle® account associated with the receiving party, and so on (e.g., step 416). From the one or more simulated transactions, the AI system 200 may recognize that for any transaction between a sending party and the “Kitchen Contractors Group,” the mean transaction amount is $8,000 and the range associated with the mean transaction amount is $6,000-$10,000 (e.g., step 418). Comparing the transaction amount of $70,000 in the transaction request to the range, the AI system 200 recognizes, using one or more vectors representing the transaction amounts, that the transaction amount in the transaction request does not fall within the range (e.g., step 420). The provider institution computing system 110 may suggest to the user, via the client application 146, designating the receiving party in the transaction request as the Zelle® account associated with “Kitchen Contractors Group” from each of the one or more previous transactions (e.g., step 421). Upon receiving an indication that the user has accepted the suggested receiving party, the provider institution computing system 110 may update the transaction request to reflect the account associated with the receiving party. The AI system 200 may then assign an individual legitimacy value of 0, out of a 10-point scale, to the transaction amount (e.g., step 422). Based on the legitimacy value of the transaction request, which is less than 10 due to the individual legitimacy value of 0 that is associated with the transaction amount, the provider institution computing system 110 determines that the transaction request may be fraudulent and/or contain one or more errors (e.g., step 424). In denying the transaction request, the provider institution computing system 110 may allow the user, via the legitimacy report transmitted to the client computing device 140, to update the transaction amount and/or to cancel the transaction request (e.g., step 425b). If the user, upon reviewing the legitimacy report, notices that they entered an extra 0 in the transaction amount, the user may update the transaction amount to be $7,000. The provider institution computing system 110 may, upon receiving the updated transaction amount as entered by the user, update the legitimacy value associated with the transaction request and, upon determining that the updated legitimacy value is 10, approve the transaction request.

In some embodiments, the method 400 may be used by the user to compare one or more parameters among a plurality of transactions. For example, the provider institution computing system 110 may present to the user one or more transaction amounts associated with the one or more previous transactions. The user may compare the one or more transaction amounts associated with the one or more previous transactions to the transaction amount associated with the first transaction request. In some embodiments, the user may compare the transaction amounts in order to confirm whether the user may be able to perform a similar transaction at a lower price. The user may, for example, identify that the transaction amount associated with a previous transaction between a user and “Kitchen Renovation Group” is $200 less than the transaction amount associated with the first transaction request. Thus, the user may determine that the Kitchen Renovation Group offers the same services at a lower rate than the Kitchen Contractors Group.

Referring now to FIG. 5, a flow diagram of a method 500 for a provider receiving a transaction request and identifying a validation key regarding the first transaction is shown, according to an example embodiment. Various operations of the method 500 may be conducted by the system 100 and particularly parts thereof (e.g., the provider institution computing system 110, the client computing device 140, and the transfer service computing system 130).

In some embodiments, method 500 may begin similarly and/or identically to method 400, as described above. For example, method 500 may begin upon a user accessing the client application 146. As shown at step 510, the provider institution computing system 110 receives a first request for a first transaction having one or more first parameters. The provider institution computing system 110 may receive the first request from the client computing device 140 via the client application 146. In some embodiments, step 510 of method 500 may be performed in a similar or identical operation as step 412 of method 400, as described above, with reference to FIG. 4.

Once the provider institution computing system 110 receives the first request, at step 510, the provider institution computing system 110 retrieves contextual information related to the first transaction, at step 512. In some embodiments, step 512 of method 500 may be performed in a similar or identical operation as step 413 of method 400, as described above, with reference to FIG. 4.

Once the provider institution computing system 110 receives the contextual information, at step 512, the provider institution computing system 110 may identify a validation key associated with the first transaction. The validation key refers to one or more pieces of information associated with the transaction (e.g., contextual information retrieved at step 512) that may be used to verify a legitimacy of the first transaction. In some embodiments, the provider institution computing system 110 may pre-encode the one or more pieces of contextual information with the validation key. For example, the one or more pieces of contextual information may include one or more calls, electronic correspondences, mail correspondences, pitches, or other materials related to the first transaction that confirm at least one of the first parameters of the first transaction (e.g., an identify of the one or more parties associated with the first transaction, an accuracy of a transaction amount associated with the first transaction, and an approval of a transaction method associated with the first transaction, and so on). The provider institution computing system 110 may encode the one or more pieces of contextual information upon the provider institution receiving the one or more pieces of contextual information. Then, upon retrieving the one or more pieces of contextual information encoded with the validation key, the provider institution computing system 110 may execute the code instructed by the validation key, as described below.

In some embodiments, the validation key may be received directly from a user in response to a prompt generated by the provider institution computing system 110 (e.g., sent to the client computing device 140 via the client application 146). The prompt generated by the provider institution computing system 110 may include a request for the user to confirm or deny one or more of the one or more first parameters associated with the first transaction. In some embodiments, the prompt may be delivered to the client computing device 140 via a push notification, a text message, an email message, etc. For example, the prompt may ask the user “Did you transfer money to John Smith?” The user may respond to the prompt by confirming that John Smith is the receiving party of the first transaction or by denying that John Smith is the receiving party. In some embodiments, upon denying that John Smith is the receiving party, the user may be further prompted to enter a correct receiving party. Upon receiving a confirmation of John Smith as the receiving party, the provider institution computing system 110 may be configured to generate the validation key indicating that John Smith is a legitimate receiving party.

In some embodiments, the code associated with the validation key prompts the provider institution computing system 110 to authenticate the first transaction relating to the first request received at step 510. In some embodiments, authenticating the first transaction includes assigning a highest legitimacy value to the first transaction (e.g., as performed by the generative AI model 204 in step 422 of method 400). Therefore, by authenticating the first transaction upon receiving a validation key associated with one or more pieces of contextual information related to the first transaction, the provider institution computing system 110 may forgo steps 414 through 421 of method 400 in order to determine the legitimacy value associated with the first transaction in method 500.

Once the provider institution computing system 110 authenticates the first transaction at step 516, the provider institution computing system 110 may approve the first request for the first transaction at step 518. Approving the first request may further include processing the first transaction as indicated by the first request. In some embodiments, approving the first request includes transmitting, to the transfer service computing system 130, instructions for a transfer service to process the first transaction. The provider institution computing system 110 may further transmit, to the client computing device 140 via the client application 146, a verification that the first request is approved and that the first transaction is processed.

Referring to FIG. 6, an example of a potential graphical user interface, interface 600, which may be presented on the client computing device 140 by one of the client applications 146 (e.g., a banking application, a transfer service application) in response to the provider institution computing system 110 suggesting one or more parameters associated with the first transaction at step 421 of method 400 is shown. As shown in FIG. 6, interface 600 may be associated with a user account of the provider institution. This is a representative, non-limited example interface, and does not necessarily include all potential functionality of various embodiments. Similarly, not all the functionality depicted is necessarily required in all embodiments.

The interface 600 may include one or more selectable elements. In some embodiments, selectable elements 605 may represent the one or more suggested parameters identified by the provider institution computing system 110 at step 421 of method 400. For example, in response to an outstanding request where the user has not designated a receiving party, the selectable elements 605 may each represent one suggested receiving party based on at least one of the contextual information, the transaction history, or the one or more simulated transactions associated with the outstanding transaction request. In addition to the selectable elements 605, interface 600 may further include a free-text box (e.g., selectable element 610) where the user can input a designated receiving party (e.g., by name, by account number, by routing number, etc.). Interface 600 may also include a selectable element 615. Selectable element 615 may be an icon, a phrase, or other graphic that allows the user to cancel the transaction request.

Upon receiving an indication that the user has interacted with at least one of the selectable elements 605 and the selectable element 610 included in interface 600, the provider institution computing system 110 may be configured to update the outstanding transaction request to include an updated one or more parameters as indicated through the user interaction with the at least one of the selectable elements 605 and the selectable element 610. In some embodiments, upon receiving an indication that the user has interacted with the selectable element 615, the provider institution computing system 110 may be configured to cancel the transaction request.

Referring to FIG. 7, an example of a potential graphical user interface, interface 700, which may be presented on the client computing device 140 by one of the client applications 146 (e.g., a banking application, a transfer service application) in response to the provider institution computing system 110 transmitting the legitimacy report (e.g., legitimacy report 710) associated with a transaction request at step 424 of method 400 is shown. As shown in FIG. 7, interface 700 may be associated with a user account of the provider institution. This is a representative, non-limited example interface, and does not necessarily include all potential functionality of various embodiments. Similarly, not all the functionality depicted is necessarily required in all embodiments.

The legitimacy report 710 may include a graphical, tabular, textual, and so on, summary of the legitimacy value associated with the first transaction (e.g., determined at step 422). For example, the legitimacy report 710, as depicted on interface 700, may include a title of the transaction request, a status of the transaction request (e.g., “approved” or “denied”), the legitimacy value associated with the first transaction (e.g., legitimacy value 715), and one or more parameters associated with the transaction request (e.g., a sending party, a receiving party, a transaction method, and a transaction amount). In addition to displaying the legitimacy value associated with the first transaction, the legitimacy report 710 may include the individual legitimacy values associated with the one or more parameters (e.g., individual legitimacy values 720). The interface 700 may include an indicator (e.g., indicator 730) of fraud and/or an error corresponding to at least one of the one or more parameters. For example, for a parameter with an individual legitimacy value (e.g., 0) below a highest individual legitimacy value (e.g., 10), the interface 700 may depict the indicator 730 such that the user can update the parameter, if desired.

For each of the one or more parameters included in the legitimacy report 710, the interface 700 may include a selectable element 725 (e.g., depicted by a pencil icon). The selectable element 725 may allow a user of the user account associated with the interface 700 to adjust the respective one or more parameters included in the legitimacy report. For example, upon interacting with the selectable element 725 associated with the transaction amount, the interface 700 may prompt the user (e.g., via a pop-up window, a free-text box, etc.) to enter a new transaction amount. Upon receiving an indication that the user has engaged with at least one selectable element 725, the provider institution computing system 110 may be configured to update the transaction request according to the adjusted parameter. For example, upon receiving the legitimacy report 710, the user may realize that the transaction amount contains an error (e.g., the user added an additional 0 to the transaction amount) and may then update the transaction amount to reflect a correct transaction amount. The legitimacy report 710 may include selectable elements (e.g., selectable element 740, selectable element 745) that may allow the user to approve or deny the transaction request based on the legitimacy report. For example, the user may identify no errors and confirm that the transaction request is not fraudulent by interacting with the selectable element 740. In some embodiments, the user may first update, using the selectable element 725, at least one of the one or more of the parameters included in the legitimacy report 710 and then, upon receiving an updated legitimacy report with the updated parameter(s), approve the transaction by interacting with the selectable element 740. Upon receiving an indication that the user has interacted with the selectable element 740, the provider institution computing system 110 may be configured to approve and process the transaction, as described above with reference to step 425a of method 400. Alternatively, the user may identify that the transaction request is fraudulent by interacting with the selectable element 745. Upon receiving an indication that the user has interacted with the selectable element 745, the provider institution computing system 110 may be configured to cancel the transaction, flag the transaction as fraudulent, and store data associated with the transaction in the fraud detection database 164.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations may depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method, comprising:
receiving, by a provider computing system and from a user device, a first request for a first transaction having one or more first parameters;
analyzing, by the provider computing system, a transaction history comprising one or more previous transactions having at least one of the one or more first parameters;
simulating, by the provider computing system using at least one artificial intelligence (AI) system, one or more transactions based on the one or more first parameters;
identifying, by the provider computing system using the at least one AI system, one or more second parameters of the one or more simulated transactions;
comparing, by the provider computing system using the at least one AI system, the one or more second parameters to the one or more first parameters;
determining, by the provider computing system using the at least one AI system, a legitimacy value associated with the first transaction based on the comparison of the one or more second parameters to the one or more first parameters;
determining, by the provider computing system, a response to the first request based on the legitimacy value associated with the first transaction; and
transmitting, by the provider computing system to the user device, the response to the first request.

2. The method of claim 1, wherein the at least one AI system comprises a generative AI model.

3. The method of claim 2, wherein the provider computing system is further configured to store information associated with the first request to serve as training data for the generative AI model.

4. The method of claim 1, wherein the one or more first parameters comprise at least one of:
a transaction amount;
one or more parties associated with the first transaction; and
a transaction method.

5. The method of claim 4, wherein the one or more parties associated with the first transaction further comprise at least one of:
a sending party; and
a receiving party.

6. The method of claim 1, the method further comprising:
generating, by the provider computing system, a key regarding the first transaction, wherein the key regarding the first transaction is configured to authenticate the first transaction.

7. The method of claim 1, the method further comprising:
retrieving, by the provider computing system, contextual information related to the first transaction from at least one data source, wherein the contextual information is used to determine at least one of the one or more first parameters.

8. The method of claim 7, the method further comprising:
suggesting one or more parameters associated with the first transaction based on at least one of the transaction history, the one or more simulated transactions, and the contextual information.

9. The method of claim 1, wherein comparing the one or more second parameters to the one or more first parameters further comprises:
receiving an accepted range associated with the one or more first parameters;
determining whether the one or more second parameters fall within the accepted range.

10. The method of claim 1, wherein the response to the first request further comprises:
approving the first request if the legitimacy value meets a predefined threshold; or
denying the first request if the legitimacy value does not meet the predefined threshold.

11. A provider computing system comprising:
at least one processing circuit having at least one processor coupled to at least one memory device, the at least one memory device storing instructions thereon that, when executed by the at least one processor, cause the at least one processing circuit to perform operations comprising:
receiving, from a user device, a first request for a first transaction having one or more first parameters;
analyzing a transaction history comprising one or more previous transactions having at least one of the one or more first parameters;
determining a response to the first request based on a legitimacy value associated with the first transaction; and
transmitting, to the user device, the response to the first request;
at least one artificial intelligence (AI) system, the at least one AI system configured to perform operations comprising:
simulating one or more transactions based on the one or more first parameters;
identifying one or more second parameters of the one or more simulated transactions;
comparing the one or more second parameters to the one or more first parameters; and
determining the legitimacy value associated with the first transaction based on the comparison of the one or more second parameters to the one or more first parameters.

12. The provider computing system of claim 11, wherein the at least one AI system comprises a generative AI model.

13. The provider computing system of claim 12, wherein the at least one AI system is further configured to store information associated with the first request to serve as training data for the generative AI model.

14. The provider computing system of claim 11, wherein the one or more first parameters comprise at least one of:
a transaction amount;
one or more parties associated with the first transaction; and
a transaction method.

15. The provider computing system of claim 11, wherein the at least one AI system is further configured to perform operations comprising:
generating a key regarding the first transaction, wherein the key regarding the first transaction is configured to authenticate the first transaction.

16. The provider computing system of claim 11, wherein the at least one processing circuit performs further operations comprising:
retrieving contextual information related to the first transaction from at least one data source, wherein the contextual information is used to determine at least one of the one or more first parameters.

17. The provider computing system of claim 16, wherein the at least one AI system is further configured to perform operations comprising:
suggesting one or more parameters associated with the first transaction based on at least one of the transaction history, the one or more simulated transactions, and the contextual information.

18. The provider computing system of claim 11, wherein comparing the one or more second parameters to the one or more first parameters further comprises:
receiving an accepted range associated with the one or more first parameters;
determining whether the one or more second parameters fall within the accepted range.

19. The provider computing system of claim 11, wherein the response to the first request further comprises:
approving the first request if the legitimacy value meets a predefined threshold; or
denying the first request if the legitimacy value does not meet the predefined threshold.

20. A non-transitory computer readable medium including instructions stored thereon that, when executed by at least one processing circuit of a provider computing system associated with a provider institution, cause the at least one processing circuit to perform operations comprising:
receiving, from a user device, a first request for a first transaction having one or more first parameters;
analyzing a transaction history comprising one or more previous transactions having at least one of the one or more first parameters;
simulating, using at least one artificial intelligence (AI) system, one or more transactions based on the one or more first parameters;
identifying, using the at least one AI system, one or more second parameters of the one or more simulated transactions;
comparing, using the at least one AI system, the one or more second parameters to the one or more first parameters;
determining, using the at least one AI system, a legitimacy value associated with the first transaction based on the comparison of the one or more second parameters to the one or more first parameters;
determining a response to the first request based on the legitimacy value associated with the first transaction; and
transmitting, to the user device, the response to the first request.
